(19) United States
(12) Patent Application Publication
(10) Pub. No.: US 2009/0071627 A1
(43) Pub. Date: Mar. 19, 2009

(54) SELF-REGULATED THERMAL ENERGY SYSTEM

(76) Inventor: Pessach Seidel, Motza Ilit (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/282,571

(22) PCT Filed: Mar. 7, 2007
(86) PCT No.: PCT/IL07/00318

§ 371 Date: Sep. 11, 2008

(30) Foreign Application Priority Data
Mar. 12, 2006 (IL) 174262

(51) Int. Cl. F28D 5/00

(52) U.S. Cl. 165/104.19

(57) ABSTRACT

The aim of the present invention is to provide a self-regulating thermal energy storage system for use in conjunction with at least one thermal energy client. The invention also discloses methods for self-regulating, the storage, and use of thermal energy in thermal energy storage system, as well as a consul for system as defined above. This consul is modulated, unitary, integrated or stands alone as a control system adapted for controlling the heated/cooled system defined above.

### FIELD OF THE INVENTION

The present invention relates to self-regulated thermal energy system, methods and consuls thereof.

### BACKGROUND OF THE INVENTION

Various approaches were taken in the art to generate thermal energy, wherein this energy is being either the presence of heat, as provided by a heating system, boiler, heat exchanger or the like, or the presence of cold, as provided by a cooling system, chiller, heat exchanger, or the like. In a simplified manner, a heat exchange system comprises two reciprocal steps: after a first thermal energy exchange, thermal energy carrier fluid is recycled from a thermal energy generator to a client, whereat a second (and opposite) thermal energy exchange is provided and vice versa.

More specifically, and as utilized in many industrial systems, the thermal energy is generated by one or more thermal energy generation sources and supplied in a predetermined capacity to at least one thermal energy client by a means of a conduit system, cycling at least one thermal energy carrier fluid, capable for effective and reversible supply of a predetermined measure of the thermal energy. In a simple case, the thermal requirements of the client are fixed and provided in a steady state along the day so that the thermal production capacity of the generator equals the thermal requirements of the client. In more complicated cases however, the thermal requirements of the client are not steady, e.g., the client's thermal requirements are temporarily lower than the generator's and solids tend to be distributed generally vertically, with warmer layers being positioned above cooler lower layers. A simple to operate and cost effective self-regulating thermal energy storage system is hence still a long felt need.

### SUMMARY OF THE INVENTION

It is an aim of the present invention to provide a self-regulating thermal energy storage system (10) for use in conjunction with at least one thermal energy client (16), which comprising: (I) at least one thermal energy generation source (12) for imparting to at least one thermal energy carrier fluid a predetermined temperature change; (II) said at least one thermal energy client (16) is communicated in series, parallel or a combination thereof to said generator (12); (III) at least one thermal energy storage reservoir (14), adapted to store thermal energy generated by said generator (12) at the time that the said client (16) does not fully utilize said energy, communicated in parallel to a bypass of said storage and in series, parallel or a combination thereof to said generator (12) and said client (16); (IV) a first and a second fluid flow directors configured so that said first director (22A) is located in an upstream junction (USJ) communicating said generator (12), client (16) and reservoir (14); said first director (22A) functions to direct the flow of said fluid from the generator (12) in at least one of two directions, namely towards said client (16) and/or towards said reservoir (14); said second director (22B) is located in a downstream junction (DSJ) communicating said generator (12), client (16) and reservoir (14), said second director (22B) functions to direct the flow of said fluid towards the generator (12) in at least one of two directions, namely from said client (16) and/or from the reservoir (14), being interconnected with the DSJ-USJ supply line, via Dc or Dh, wherein Dc or Dh is a junction communicating said reservoir (14) and said DSJ-USJ supply line junction; wherein the thermal energy consumption of said client (16) equals the thermal energy generation capacity of said generator (12), said fluid is circled directly from said generator (12) to said client (16) via said USJ, and vice versa, from said client (16) to said generator (12) via said DSJ; and, wherein the momentary thermal energy requirements of said client (16) is lower than the thermal energy generation capacity of said generator (12), only a portion of said fluid is circled from said generator (12) to said client (16) via said USJ, and the remaining portion is supplied by said first director (22A) towards said reservoir (14), in case said generator (12) is adapted to cool said client (16) (a cooling system), a cold fluid is supplied to said lower portion of said reservoir (14) thereby to cause a release of heat from the relatively warm layers of said storage medium in said upper portion thereof, yet in case said generator (12) is adapted to heat said client (16) (a heating system), a worm fluid is supplied to said higher portion of said reservoir (14) thereby to cause a release of cold fluid from the relatively cold layers of said storage medium in said lower portion thereof, fluids provided from said reservoir (14) and said client (16) are admixed in said DSJ, and supplied to said generator (12) by said second director (22B); in a particular case, wherein the momentary thermal energy requirements of said client (16) is approximately zero, said fluid is circled directly from said generator (12) to said reservoir (14) via said USJ, preferably until the temperature of the outlet fluid at DSJ equals the inlet fluid at USJ.

More specifically, the aim of the present invention is to disclose the self-regulated thermal system (1) that is additionally comprises a first temperature sensor (12S) and a second temperature sensor (16S), said first sensor (12S) is located upwardly to said generator (12) and a second temperature sensor (16S) located downwardly to said client (16); said first sensor (12S) is in communication with said second director (22A) at the DSJ via a first processing means (PLVB), and said second sensor (16S) is in communication with said first director (22A) at the USJ via a second processing means (PLVA); said processing means (PLVA, PLVB) are adapted to regulate said directors, such that wherein the thermal energy generating capacity of said generator (12) is lower than the thermal energy capacity (i.e., fluid temperature folded fluid flux) of fluid outlet of said DSJ, said second director (22B) is supply higher portion of fluid that is directed from said reservoir (14); and, wherein the momentary energy requirements of the thermal energy client (16), namely the temperature of the fluid exit said client (16) is different from a predetermined measure, said first director (22A) is regulating the fluid outlet of USJ in a manner that less fluid is supplied to said reservoir (14) and more fluid is supplied to said client (146), and vice versa.

Moreover, the present invention discloses a consul (20) for system (10) as defined above. The consul is adapted to control and interconnect modules selected from a group consisting of at least one thermal energy client (16, e.g., three clients 16/1, 16/2 and 16/3); at least one reservoir (14); at least one thermal energy generation source (12, e.g., two clients 12/1 and 12/2); at least one first (22A, e.g., three FFDs 22A1, 22A2 and 22A3) and at least one second (22B, e.g., two FFDs 22B1 and 22B2) fluid flow directors; at least one upstream junction (USJ); at least one downstream junction,(DSJ); supply lines; temperature sensors (12S, 16S), a first processing means (PLVB), and a second processing means (PLVA), chillers (3), solar collectors (1), supply or collecting lines (i.e., lines being parallel, in series, bypass or a combination thereof), and/or connections thereof, or any combination thereof. The consul is modulated, unitary, integrated or stands alone as is control system adapted for controlling the heated/cooled system defined above.

### BRIEF DESCRIPTION OF DRAWINGS

The present invention will be understood and appreciated more fully from the following detailed description taken in conjunction with the drawings in which:

FIGS. 1 and 2 are schematic diagrams of self-regulated thermal systems (10) adapted for cooling (FIG. 1) and heating (FIG. 2) a client according to two embodiments of the present invention;

FIG. 3 is a schematic diagram of a self-regulated thermal system (10) for heating a client by a set of solar collectors according to yet another embodiment of the present invention;

FIG. 4 is a schematic diagram of a self-regulated thermal system (10) for heating a client by a set of solar collectors, with a set of reservoirs according to yet another embodiment of the present invention;

FIG. 5 is a schematic diagram of a self-regulated thermal system (10) for heating a set of clients by a set of solar collectors according to yet another embodiment of the present invention;

FIG. 6 is a schematic diagram of a self-regulated thermal system (10) for heating and/or cooling a set of clients by a various thermal generators according to yet another embodiment of the present invention;

FIG. 7 is a schematic diagram of a self-regulated thermal system (10) for heating a set of end users (domestic water systems for example) via one or more heat exchangers (client 16) by a thermal generator and a set of reservoirs according to yet another embodiment of the present invention;

FIGS. 8A and 8B are schematic diagrams of a self-regulated thermal system (10) provided in a consul 20 according to another set of embodiments of the present invention;

FIG. 9 is a schematic diagram (front view) of a self-regulated thermal system (10) provided in a unitary consul 21 according to yet another embodiment of the present invention;

FIG. 10 is a schematic diagram (side cross section) of a self-regulated thermal system (10) provided in a unitary consul 21 according to yet another embodiment of the present invention;

FIG. 11 is a schematic diagram (front view and cross sections) of a self-regulated thermal system (10) provided in a linear modulated consul 22 according to yet another embodiment of the present invention; and,

FIGS. 12A-12D are schematic diagrams (front view) of a self-regulated thermal system (10) provided in a curved unitary consul 21 integrated with reservoir 14 according to another set of embodiments of the present invention.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide self-regulating thermal energy storage system and self-regulating method.

The term ‘Energy generation source’ or ‘generator’ refers hereinafter to any source of heat and/or cold. For example, it may be an electric or diesel powered boiler, a solar powered system, a geothermal system or the like; a chiller, or cold river or sea water or the like etc.

The term ‘Energy client’ or ‘client’ refers hereinafter to any ‘beneficiary’ of the stored energy to which energy (heat or cold) generated in the energy generation source is provided. The client can be a liquid, such as, freshly produced milk to be cooled, a solid, such as a molten iron to be cooled, or gas, such as air in an air cooling system. The client may receive the energy either directly or indirectly, for example, via a heat exchanger.

The term ‘Energy reservoir’ or ‘reservoir’ refers hereinafter to any body containing a thermal storage medium having a thermal heat capacity which may change phase or temperature. This medium stores either heat or cold energy by accumulation in thermal layers at a time when energy is generated and releases it to the client when it is required. This latter situation may arise when the energy required by the client at a particular moment is greater than the momentary energy production capacity of the energy generation source. The thermal storage medium may be a solid, such as, rock gravel, as used in domestic heat/cold reservoir systems, liquid, such as any suitable brine solution, or gas, such as steam, and so on. Most preferably, the thermal storage medium is a medium in which thermal layering occurs.

The term ‘Conduit system’ refers hereinafter to conduit system transfers energy from the energy generation source to the energy reservoir and/or to the energy client. It may include, as required, piping, ducts, valves, blowers, and pumps, and, generally, all hardware components that are required to facilitate energy transfer among the other system components. The conduit system may be open or closed, as will be appreciated from the detailed description herein.

The term ‘Control system’ refers hereinafter to any control equipment and software including thermostats, mechanized valve controllers, computer controls for pumps and blowers etc.

The term ‘consul’ refers hereinafter to any central control system adapted to control and interconnect modules selected inter alia from a group consisting of conduits and tubing, reservoirs, heating/cooling means, detectors and regulators and valves. Fluids (e.g., water) and power (e.g., electricity) supplies, etc., especially to at least partially integrated or stand-alone consuls, and to at least partially modular or all-included (As Is) consuls.

The term ‘thermal energy carrier fluid’ refers to at least one type of water, water solutions, water immiscible solutions, polyethylene glycol, ice, ice-water mixtures or any other fluids useful as a phase change materials, flowing aggregates or microcapsules which encapsulate a phase change material, etc. The ice can be hence reciprocally liquefied by a stream of respectively hot fluids, interchangeably transverse form a solid state to a liquid state. Optionally, the thermal energy carrier fluid is forcefully flow by a means of at least one valve, pump, rotating screw, reciprocally actuated piston, blower, compressor or the like.

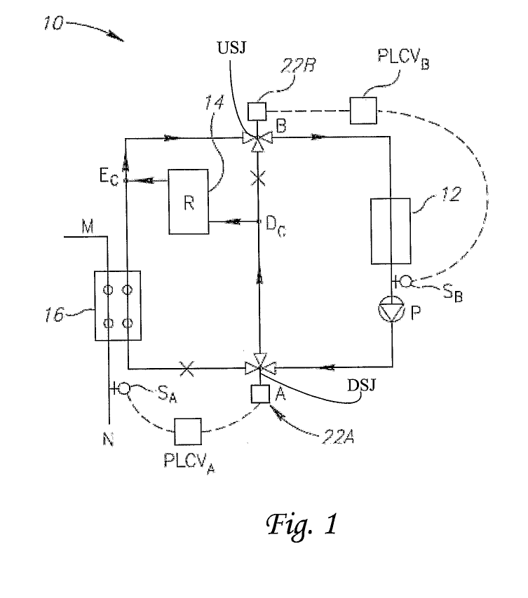

Referring now to FIG. 1 it is seen that a self-regulating thermal energy storage system (10) according to one embodiment of the present invention. System (10) is use in conjunction with at least one thermal energy client (16). The system is especially useful for cooling, i.e., wherein the client requires cold supply, and comprises inter alia the following modules: At least one thermal energy generation source (12), useful for imparting to at least one thermal energy carrier fluid a predetermined temperature change. At least one thermal energy client (16) is communicated in series, parallel or a combination thereof to generator (12). At least one thermal energy storage reservoir (14) is adapted to store thermal energy generated by generator (12) at the time that the client (16) does not fully utilize energy. Reservoir (14) is communicated in parallel to a bypass of said storage and in series, parallel or a combination thereof to generator (12) and client (16).

System (10) further comprises in a non-limiting manner a first and a second fluid flow directors. The directors are configured so that the first director (22A) is located in an upstream junction (USJ) communicating the generator (12), client (16) and reservoir (14). The first director (22A) functions to direct the flow of fluid from the generator (12) in at least one of two directions, namely towards client (16) and/or towards reservoir (14).

The second director (22B) is located in a downstream junction (DSJ) communicating generator (12), client (16) and reservoir (14), second director (22B) functions to direct the flow of said fluid towards the generator (12) in at least one of two directions, namely from client (16) and/or from the reservoir (14), being interconnected with the DSJ-USJ supply line, via Dc in a cooling system, or via Dh in a heating system, wherein Dc and/or Dh is a junction communicating said reservoir (14) and the DSJ-USJ supply line junction.

In a simple case that the thermal energy consumption of client (16) equals the thermal energy generation capacity of generator (12), the fluid is circled directly from generator (12) to client (16) via USJ, and vice versa, from said client (16) to generator (12) via DSJ.

In another situation, however, wherein the momentary thermal energy requirements of client (16) is lower than the thermal energy generation capacity of generator (12), only a portion of the fluid is circled from said generator (12) to client (16) via USJ, and the remaining portion is supplied by first director (22A) towards reservoir (14).

In a case that generator (12) is adapted to cool client (16) (a cooling system, such depicted in FIG. 1), a cold fluid is supplied to said lower portion of reservoir (14) thereby to cause a release of heat from the relatively warm layers of said storage medium in said upper portion thereof.

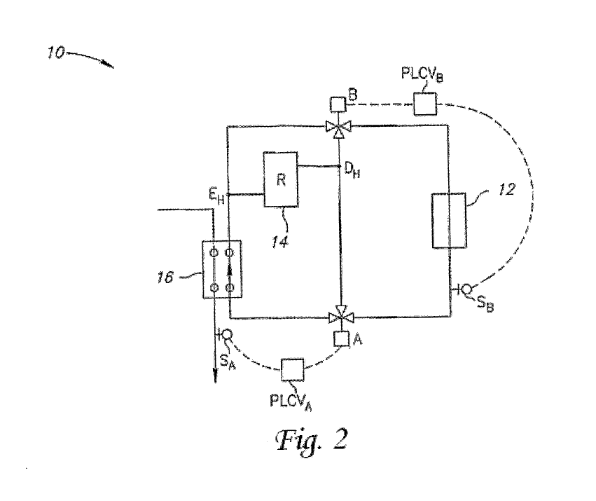

Yet in case generator (12) is adapted to heat client (16) (a heating system, See FIG. 2), a worm fluid is supplied to higher portion of reservoir (14) thereby to cause a release of cold fluid from the relatively cold layers of storage medium in the lower portion thereof. Fluids provided from reservoir (14) and client (16) are admixed in said DSJ, and supplied to generator (12) by second director (22B); in a particular case, wherein the momentary thermal energy requirements of the client (16) is approximately zero, the fluid is circled directly from the generator (12) to the reservoir (14) via the USJ, preferably until the temperature of the outlet fluid at DSJ equals the inlet fluid at USJ.

System (10) as defined in any of the above may additionally comprise various sensors and hence provide for a feed backed regulation. Here for example and according to another embodiment of the present invention, a first temperature sensor (12S) and a second temperature sensor (16S) are provide in a non-limiting manner. The first sensor (12S) is located upwardly to generator (12) and a second temperature sensor (16S) located downwardly to client (16). The first sensor (12S) is in communication with the second director (22A) at the DSJ via a first processing means (PLV_{B}). The second sensor (16S) is in communication with the first director (22A) at the USJ via a second processing means (PLV_{A}).

The processing means (PLV_{A}, PLV_{B}) are adapted to regulate the aforesaid directors, such that wherein the thermal energy generating capacity of generator (12) is lower than the thermal energy capacity (i.e., fluid temperature folded fluid flux) of fluid outlet of the DSJ, the second director (22B) is supply higher portion of fluid that is directed from the reservoir (14). Additionally or alternatively, wherein the momentary energy requirements of the thermal energy client (16), namely the temperature of the fluid exit client (16) is different from a predetermined measure, the first director (22A) is regulating the fluid outlet of USJ in a manner that less fluid is supplied to reservoir (14) and more fluid is supplied to client (146), and vice versa. It is acknowledged in this respect that reservoir 14 may contain at least one of the aforesaid junctions and tubing within its inner volume.

It is according to one embodiment of the present invention wherein more than one generator is provided; especially wherein the generators are being interconnected in a series and/or parallel. It is according to another embodiment of the present invention wherein more than one reservoir is provided more than one reservoir; said reservoirs are being interconnected in a series and/or parallel. It is according to another embodiment of the present invention wherein more than one client is provided, especially wherein the clients are being interconnected in a series and/or parallel.

It is according to another embodiment of the present invention wherein system (10) is utilized wherein more than one generator is provided especially adapted for both heating and cooling at least one client (16), wherein said reservoir (12) is interconnected with the DSJ-USJ line and the client-DSJ in both its upper and lower portions.

It is according to another embodiment of the present invention wherein system (10) is utilized with or without valves or regulators, and with or without pumping means.

The present invention also discloses a cost effective and novel method for self-regulating the storage and use of thermal energy in thermal energy storage system (10) as defined in any of the above. The method comprises inter alia steps of
(i) selectably supplying heat to the upper portion of reservoir (14), thereby causing a release of cold from the relatively cold layers of the storage medium in the lower portion thereof; and
(ii) (ii) selectably supplying cold to the lower portion of reservoir (14) thereby to causing a release of heat from the relatively warm layers of said storage medium in the upper portion thereof, in accordance with the momentary energy requirements of the thermal energy client (16) and the momentary generation capability of generation source (12).

The method described above may additionally comprising steps of:
(i) providing a plurality of fluid flow directors (22A, 22B) configured to assure that the volumetric flow of said thermal energy carrier fluid to the thermal energy client (16) and the thermal energy storage reservoir (14) is in accordance with the momentary energy requirements of the energy client (16) and the capability of thermal energy generated by the thermal energy generation source (12);
(ii) locating said first director in an upstream junction (USJ) communicating generator (12), client (16) and reservoir (14);
(iii) functioning first director (22A) to direct the flow of the fluid from generator (12) in at least one of two directions, namely towards the client (16) and/or towards the reservoir (14);
(iv) locating the second director (22B) in a downstream junction (DSJ) communicating said generator (12), client (16) and reservoir (12);
(v) functioning the second director (22B) to direct the flow of the fluid towards generator (12) in at least one of two directions, namely from client (16) and/or from reservoir (14), being interconnected with the DSJ-USJ supply line.

The method is especially useful wherein the thermal energy consumption of client (16) is equal to the thermal energy generation capacity of said generator (12). In this case, the method defines a step of circulating the fluid directly from generator (12) to client (16) via the USJ, and vice versa, from client (16) to generator (12) via DSJ.

Alternatively, method is especially useful wherein the momentary thermal energy requirements of client (16) is lower than the thermal energy generation capacity of generator (12), supplying only a portion of said fluid from generator (12) to said client (16) via the USJ, and supplying the remaining portion by the first director (22A) towards said reservoir (14).

In a case that generator (12) is adapted to cool the client (16) (a cooling system, FIG. 1), a step of supplying a cold fluid to the lower portion of reservoir (14) is provided, allowing a release of heat from the relatively warm layers of the storage medium in the upper portion thereof.

Yet in a case generator (12) is adapted to heat said client (16) (a heating system, FIG. 2), the following steps are provided:
(i) supplying a worm fluid to the higher portion of reservoir (14) is provided, allowing a release of cold fluid from the relatively cold layers of the storage medium in the lower portion thereof;
(ii) admixing fluids provided from reservoir (14) and client (16) in the DSJ; and,
(iii) supplying the same to generator (12) by second director (22B).

In a particular case, the momentary thermal energy requirements of client (16) is approximately zero. Here, a step of circulating the fluid directly from generator (12) to reservoir (14) via the USJ is provided, preferably until the temperature of the outlet fluid at DSJ equals the inlet fluid at USJ.

It is according to yet another embodiment of the present invention, wherein the first temperature is higher than the second temperature and the first extreme position is substantially near the top of said reservoir (14) and the second extreme position is substantially near the bottom of said reservoir (14).

It is according to yet another embodiment of the present invention, wherein the first temperature is lower than the second temperature and the first extreme position is substantially near the bottom of said reservoir (14) and the second extreme position is substantially near the top of said reservoir (14).

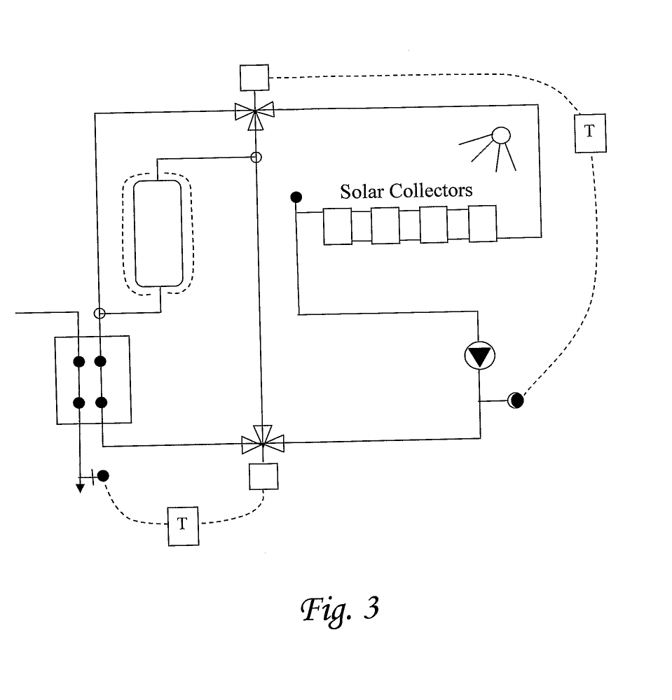

Reference is now made to FIG. 3, presenting system (10) according to yet another embodiment of the present invention, wherein ‘the generator’ is an array of one or more solar collectors interconnected in series, in parallel or in any combination thereof.

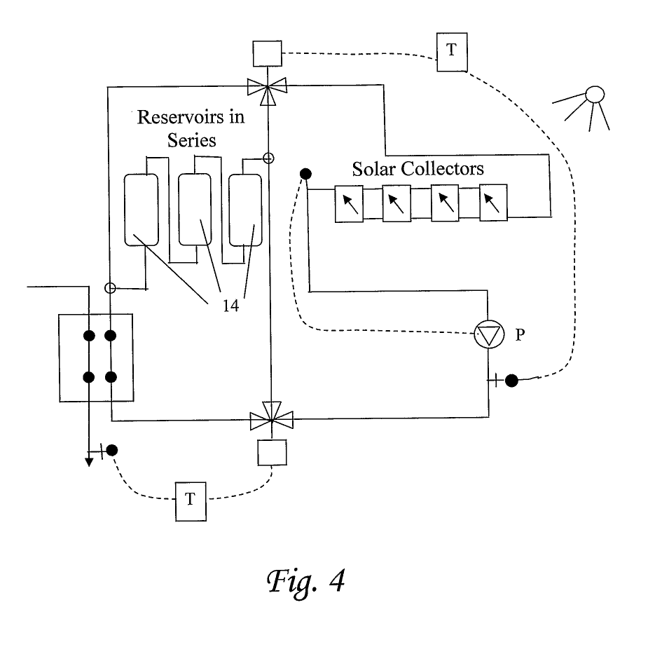

Reference is made now to FIG. 4, presenting system (10) according to yet another embodiment of the present invention. This system is including a generators array (here, solar array of FIG. 3) and a plurality of interconnected reservoirs, being interconnected either in series, in parallel or in any combination thereof.

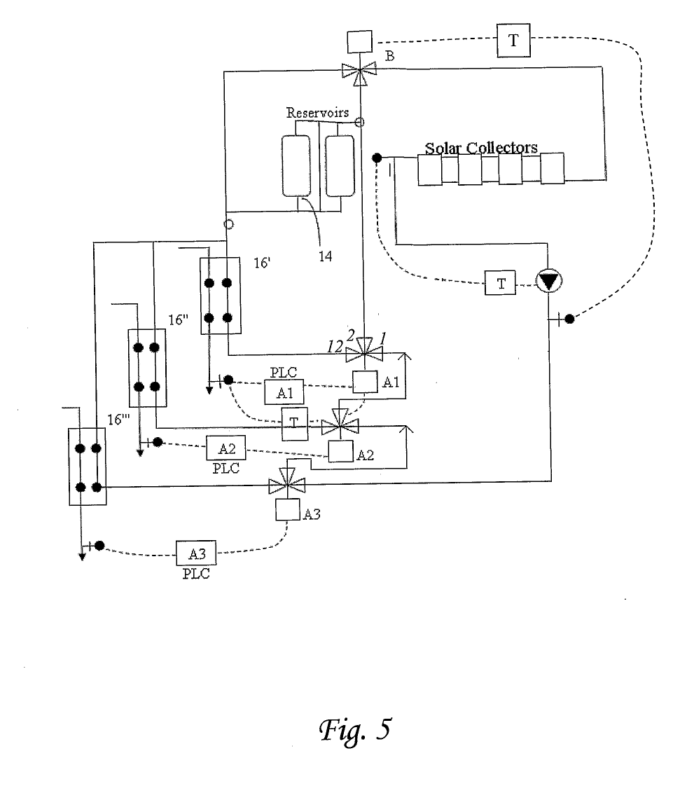

Reference is made now to FIG. 5, presenting system (10) according to yet another embodiment of the present invention. This system is including an array of generators (here, solar array of FIG. 3) and a plurality of interconnected reservoirs (here, two reservoirs of FIG. 4), and a plurality (e.g., three) of clients, being interconnected either in series, in parallel or in any combination thereof. It is acknowledged in this respect that tubing of the reservoir can be either in parallel or in series. It is in the scope of the invention wherein valves A1-A3 are designed in a manner that flow direction is selected form one of three alternatives, namely (1), (2) or (1&2) (See A1).

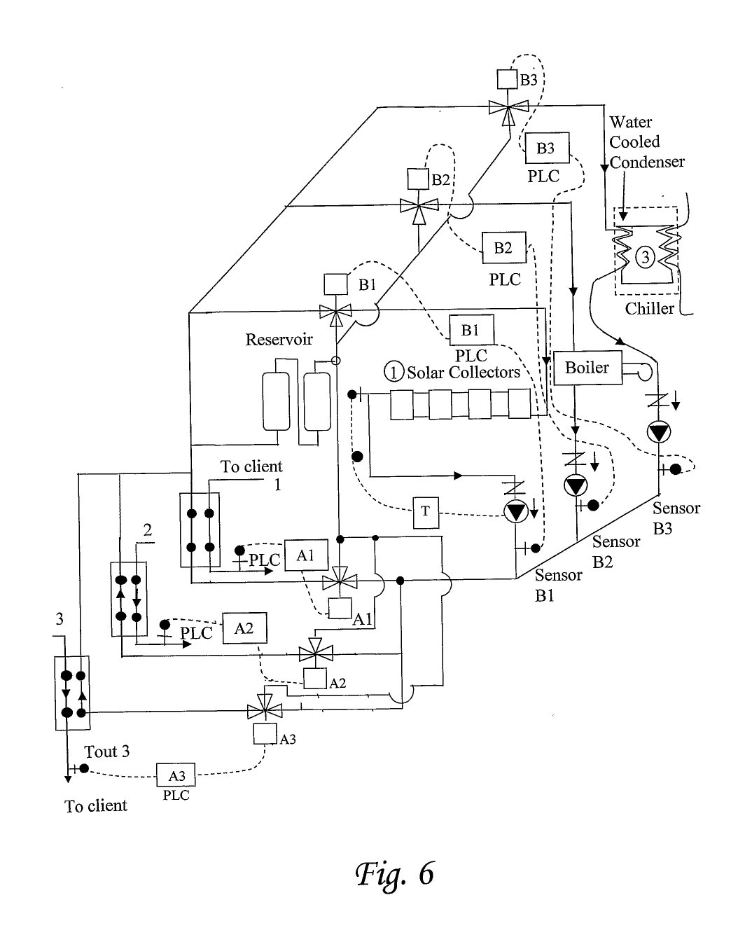

Reference is made now to FIG. 6, presenting a plurality of self-regulated thermal systems (as system 10) according to yet another embodiment of the present invention, being interconnected in parallel, is series or in a combination thereof, especially adapted for both cooling and/or heating a plurality of clients, wherein the clients are being interconnected in parallel, is series or in a combination thereof, especially adapted for both cool or heat a plurality of clients. This system is including an array of generators (here, solar array of FIG. 3), a boiler etc., condenser and/or a chiller. Also illustrated is a plurality of interconnected reservoirs, here, two reservoirs as described in FIG. 4.

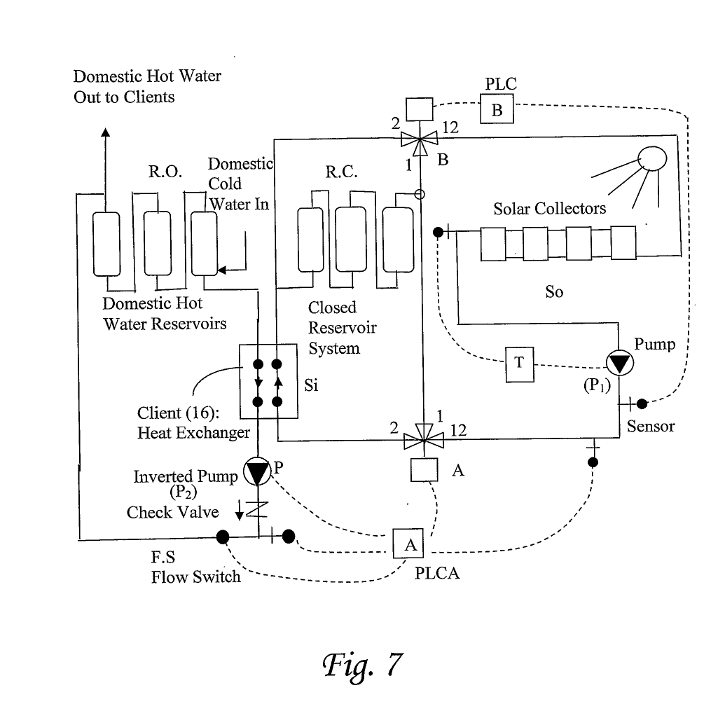

Reference is now made to FIG. 7, presenting another embodiment of the self-regulated thermal system (10) according to the present invention. Here an array of four solar collectors generate heat to a central heat exchanger, which supplies heat to a plurality of end users, here domestic clients for either hot and cold water. A cascade of three reservoirs is used.

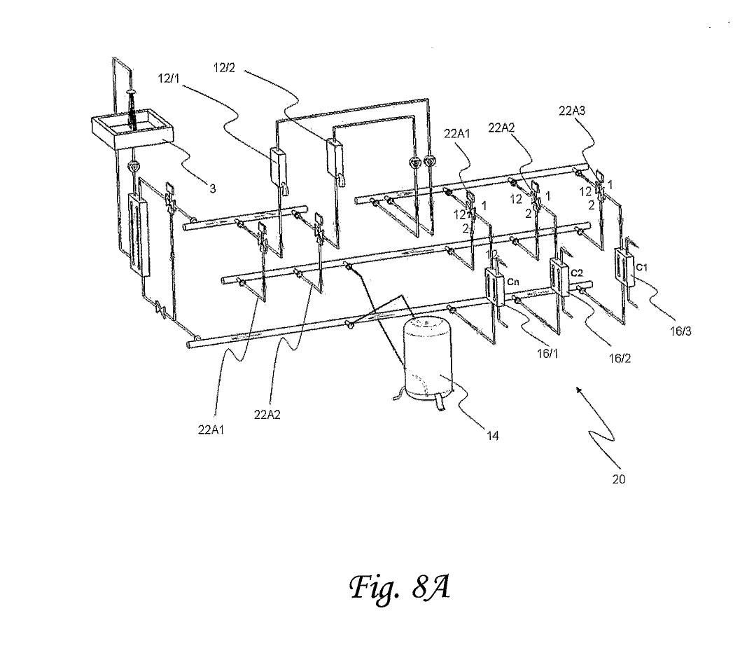

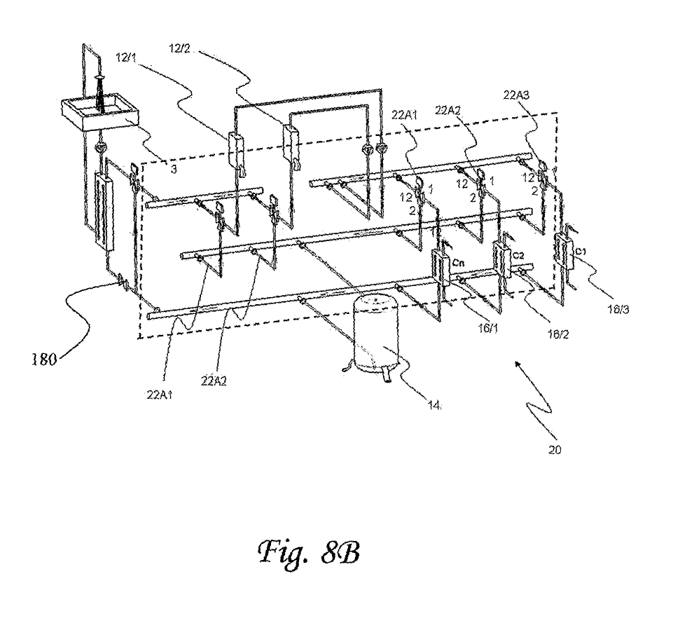

Reference is now made to FIGS. 8A and 8B, presenting another embodiment of the self-regulated thermal system (10) according to the present invention, at least partially or temporarily arrayed in consul (20). The tubing provided in system 10 is arranged in consul 20. This unique array is adapted to control and interconnect modules selected in a non-limiting manner from a group consisting of at least one thermal energy client (16), here three clients 16/1, 16/2 and 16/3; at least one reservoir (14); at least one thermal energy generation source (12), here, two clients 12/1 and 12/2; at least one first (22A), here, fluid flow directors (FFDs) 22A1, 22A2 and 22A3; and at least one second (22B) here, two FFDs 22B1 and 22B2; valves, solenoids or the like, at least one upstream junction (USJ); at least one downstream junction (DSJ, not marked here); supply lines; temperature sensors (the 12S, 16S, not marked here), a first processing means (PLVB, not marked here), and a second processing means (PLVA, not marked here), chillers (3), solar collectors (1, not shown here), supply or collecting lines (i.e., lines being parallel, in series, bypass or a combination thereof), and/or connections thereof, or any combination thereof. FIG. 8 illustrates a configuration wherein reservoir 14 is adapted for cold/hot system, and is respectfully connected to the system by changeable tubing. FIG. 8B illustrates the integrated consul, adapted to be immobilized to the cooling/heating system, e.g., wherein dashed line 108 is the reservoir's 14 outer shall.

The system controlled by consul 10 also comprises a plurality of valves, e.g., a first and a second fluid flow directors. The directors are configured so that the first director (22A) is located in an upstream junction (USJ, not marked) communicating the generator (12), client (16) and reservoir (14). The first director (22A) functions to direct the flow of fluid from the generator (12) in at least one of two directions, namely towards client (16) and/or towards reservoir (14).

The second director (22B) is located in a downstream junction (DSJ, not marked) communicating generator (12), client (16) and reservoir (14), second director (22B) functions to direct the flow of said fluid towards the generator (12) in at least one of two directions, namely from client (16) and/or from the reservoir (14), being interconnected with the DSJ-USJ supply line, via Dc in a cooling system, or via Dh in a heating system, wherein Dc and/or Dh (not marked) is a junction communicating said reservoir (14) and the DSJ-USJ supply line junction.

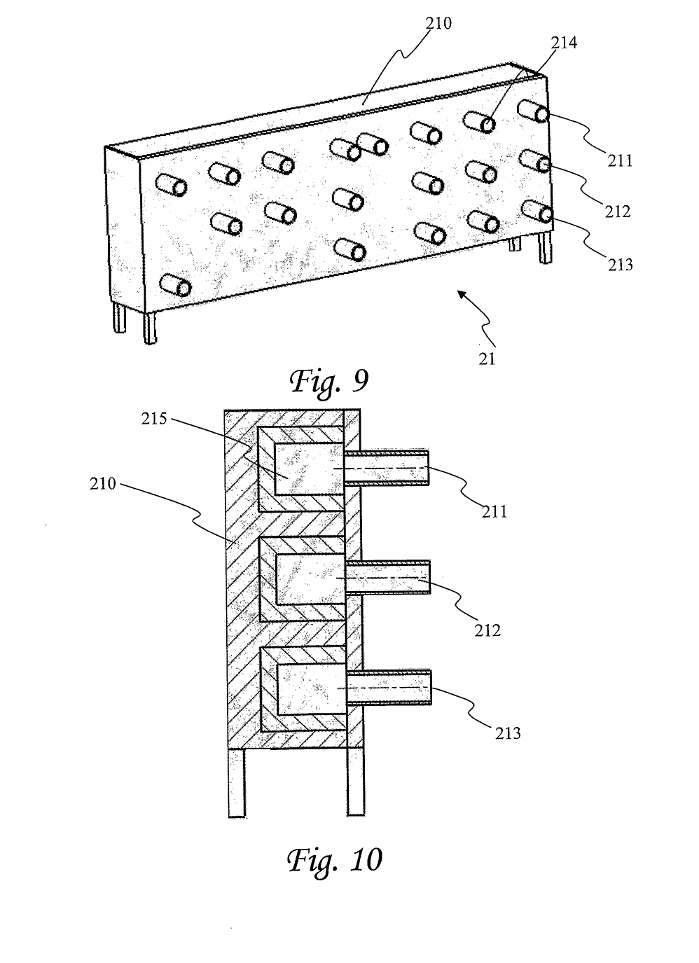

Reference is now made to FIG. 9 and FIG. 10, presenting a 3D illustration and lateral cross section, respectively, of a unitary consul (21) according to one embodiment of the present invention. This consul is arranged in a manner presented in FIG. 8 above, and adapted to comprise of an array of connectors (e.g., 211-214), at least partially interconnected by a means of a plurality of conduits (e.g., 215) accommodated within a consul's block (210).

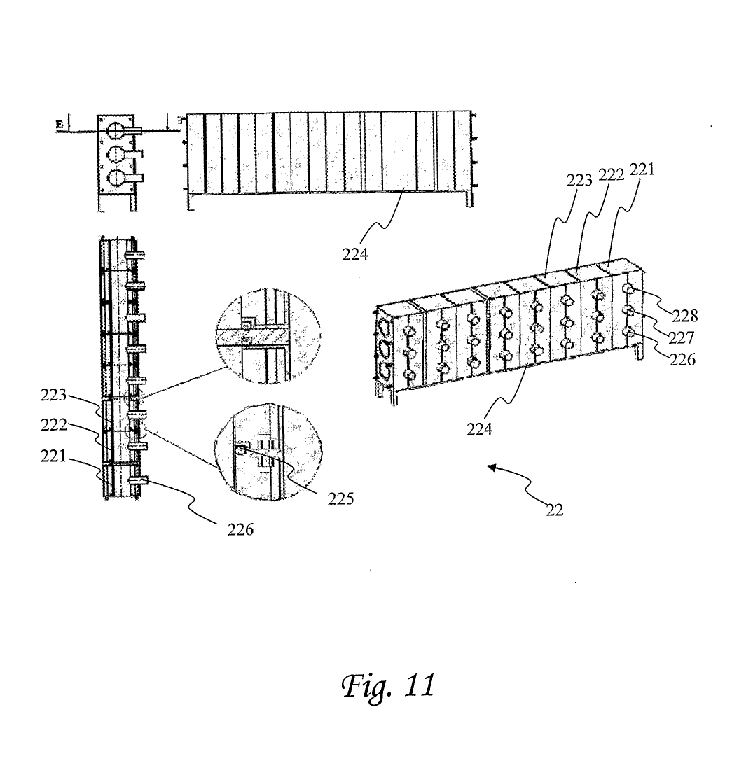

Reference is made now to FIG. 11, illustrating a modular consul (22) according to yet another embodiment of the present invention, wherein system 10 is arranged by providing an array of interconnectable modules (e.g., 221-223), each module comprising a plurality of connectors (e.g., 226-228), each of said modules is at least partially and at least reversibly interconnected to at least one, possibly two or more adjacent modules, at least a portion of said modules comprising one or more conduits accommodated within or externally to said module, such as a modular block of interconnected N modules (224) is obtained. N is an integer number between 1 to e.g., several hundreds. Adjacent modules are interconnected by any suitable means, e.g., by male-female physical connection, secured by an O-ring sealing (225) or interlocks or the like.

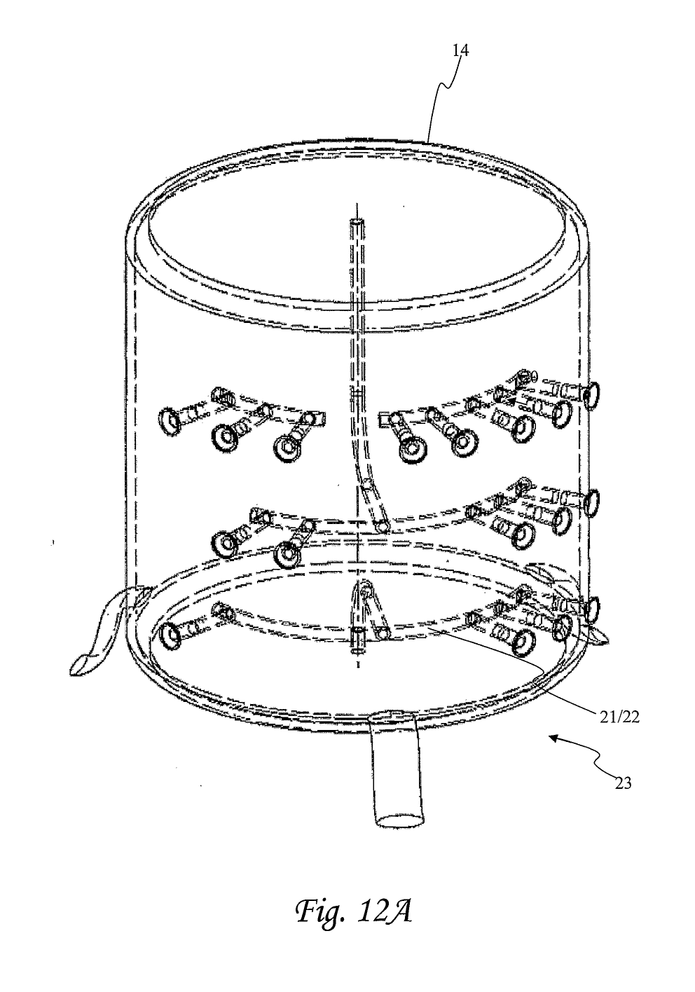

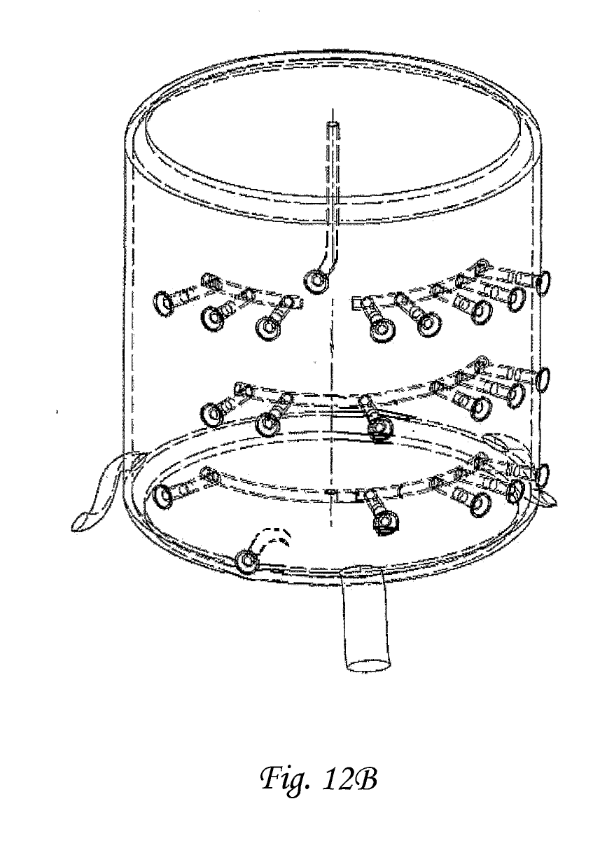

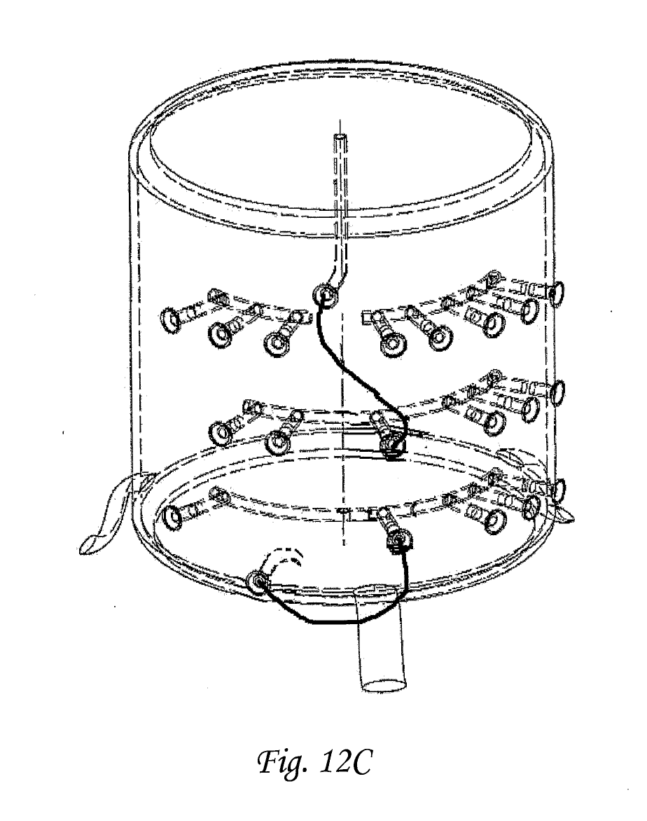

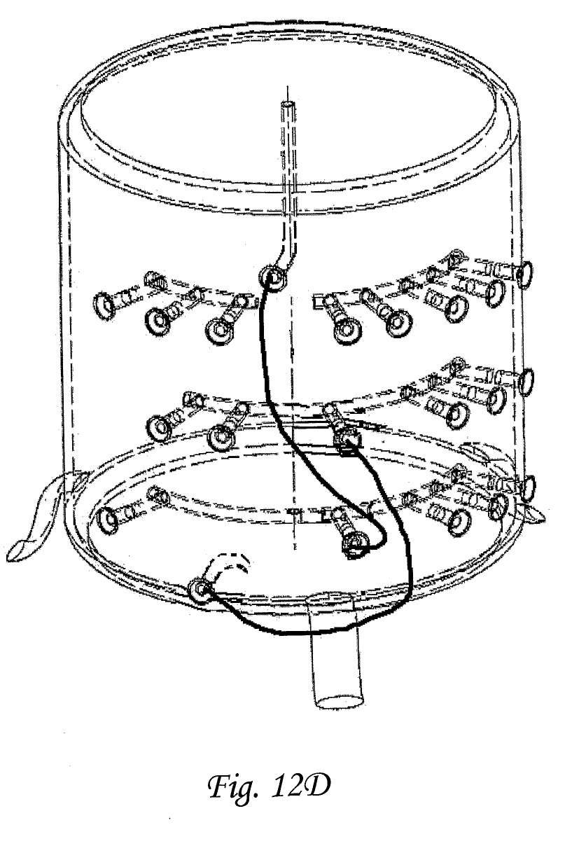

It is in the scope of the invention wherein the aforesaid consuls are adapted to be remotely interconnected with system 10. Additionally or alternatively, it is in the scope of the invention wherein the aforesaid consuls are adapted to be at least partially integrated with system 10. Reference is now made to FIGS. 12A-12D, illustrating consul 23 being either modular consul 22 or unitary consul 21, further being at least partially immobilized or mounted on reservoir 14. FIG. 12A illustrates a consul with inner tubings directing fluids inwards and outwards. FIG. 12B illustrates a consul with outer tubings directing fluids inwards and outwards. FIG. 12C illustrates an integrated consul in a cooling mode, wherein FIG. 12D illustrates an integrated consul in a heating mode.

1. A self-regulating thermal energy storage system (10) for use in conjunction with at least one thermal energy client (16), which comprising:
a. at least one thermal energy generation source (12) for imparting to at least one thermal energy carrier fluid a predetermined temperature change;
b. said at least one thermal energy client (16) is communicated in series, parallel or a combination thereof to said generator (12);
c. at least one thermal energy storage reservoir (14), adapted to store thermal energy generated by said generator (12) at the time that the said client (16) does not fully utilize said energy, communicated in parallel to a bypass of said storage and in series, parallel or a combination thereof to said generator (12) and said client (16);
d. a first and a second fluid flow directors configured so that
said first director (22A) is located in an upstream junction (USJ) communicating said generator (12), client (16) and reservoir (14); said first director (22A) functions to direct the flow of said fluid from the generator (12) in at least one of two directions, namely towards said client (16) and/or towards said reservoir (14);
said second director (22B) is located in a downstream junction (DSJ) communicating said generator (12), client (16) and reservoir (14), said second director (22B) functions to direct the flow of said fluid towards the generator (12) in at least one of two directions, namely from said client (16) and/or from the reservoir (14), being interconnected with the DSJ-USJ supply line, via Dc or Dh wherein Dc or Dh is a junction communicating said reservoir (14) and said DSJ-USJ supply line junction;
wherein the thermal energy consumption of said client (16) equals the thermal energy generation capacity of said generator (12), said fluid is circled directly from said generator (12) to said client (16) via said USJ, and vice versa, from said client (16) to said generator (12) via said DSJ; and,
wherein the momentary thermal energy requirements of said client (16) is lower than the thermal energy generation capacity of said generator (12), only a portion of said fluid is circled from said generator (12) to said client (16) via said USJ, and the remaining portion is supplied by said first director (22A) towards said reservoir (14),
in case said generator (12) is adapted to cool said client (16) (a cooling system), a cold fluid is supplied to said lower portion of said reservoir (14) thereby to cause a release of heat from the relatively warm layers of said storage medium in said upper portion thereof,
yet in case said generator (12) is adapted to heat said client (16) (a heating system), a worm fluid is supplied to said higher portion of said reservoir (14) thereby to cause a release of cold fluid from the relatively cold layers of said storage medium in said lower portion thereof,
fluids provided from said reservoir (14) and said client (16) are admixed in said DSJ, and supplied to said generator (12) by said second director (22B);
in a particular case, wherein the momentary thermal energy requirements of said client (16) is approximately zero, said fluid is circled directly from said generator (12)to said reservoir (14) via said USJ, preferably until the temperature of the outlet fluid at DSJ equals the inlet fluid at USJ.

2. System (10) according to claim 1, additionally comprising a first temperature sensor (12S) and a second temperature sensor (16S), said first sensor (12S) is located upwardly to said generator (12) and a second temperature sensor (16S) located downwardly to said client (16); said first sensor (12S) is in communication with said second director (22A) at the DSJ via a first processing means (PLVB), and said second sensor (16S) is in communication with said first director (22A) at the USJ via a second processing means (PLVA);
said processing means (PLVA, PLVB) are adapted to regulate said directors, such that wherein the thermal energy generating capacity of said generator (12) is lower than the thermal energy capacity (i.e., fluid temperature folded fluid flux) of fluid outlet of said DSJ, said second director (22B) is supply higher portion of fluid that is directed from said reservoir (14); and,
wherein the momentary energy requirements of the thermal energy client (16), namely the temperature of the fluid exit said client (16) is different from a predetermined measure, said first director (22A) is regulating the fluid outlet of USJ in a manner that less fluid is supplied to said reservoir (14) and more fluid is supplied to said client (146), and vice versa.

3. System (10) according to claim 1, comprising more than one generator; said generators are being interconnected in a series and/or parallel.

4. System (10) according to claim 1, comprising more than one reservoir; said reservoirs are being interconnected in a series and/or parallel.

5. System (10) according to claim 1, comprising more than one client; said clients are being interconnected in a series and/or parallel.

6. System (10) according to claim 1, especially adapted for both heating and cooling at least one client (16), wherein said reservoir (12) is interconnected with the DSJ-USJ line and the client-DSJ in both its upper and lower portions.

7. A consul (20) for system (10) as defined in claim 1; said consul is adapted to control and interconnect modules selected from a group consisting of at least one thermal energy client (16, e.g., three clients 16/1, 16/2 and 16/3); at least one reservoir (14); at least one thermal energy generation source (12, e.g., two clients 12/1 and 12/2); at least one first (22A, e.g., three FFDs 22A1, 22A2 and 22A3) and at least one second (22B, e.g., two FFDs 22B1 and 22B2) fluid flow directors; at least one upstream junction (USJ); at least one downstream junction (DSJ); supply lines; temperature sensors (12S, 16S), a first processing means (PLVB), and a second processing means (PLVA), chillers (3), solar collectors (1), supply or collecting lines (i.e., lines being parallel, in series, bypass or a combination thereof), and/or connections thereof, or any combination thereof.

8. A unitary consul (21) according to claim 7, comprising an array of connectors (e.g., 211-214), at least partially interconnected by a means of a plurality of conduits (e.g., 215) accommodated within a consul's block (210).

9. A modular consul (22) according to claim 7, comprising an array interconnectable modules (e.g., 221-223), each module comprising a plurality of connectors (e.g., 226-228), each of said modules is at least partially and at least reversibly interconnected to at least one, possibly two or more adjacent modules, at least a portion of said modules comprising one or more conduits accommodated within or externally to said module, such as a modular block of interconnected N modules (224) is obtained.

10. The consuls according to claim 7 or any of its dependent claims, adapted to be at remotely interconnected with system 10.

11. The consuls according to claim 7 or any of its dependent claims, adapted to be at least partially integrated with system 10.

12. A consul 23 according to claim 11, wherein either modular 22 or unitary consul 21 is at least partially immobilized or mounted on reservoir 14.

13. A method for self-regulating the storage and use of thermal energy in thermal energy storage system (10) which comprising at least one thermal energy generation source (12) for imparting to at least one thermal energy carrier fluid a predetermined temperature change; at least one thermal energy storage reservoir (14) for accumulating said thermal energy carrier fluid whose temperature has been changed by a predetermined value, said reservoir (14) containing at least one thermal energy storage medium, which is susceptible to thermal layering, said reservoir having a lower portion and an upper portion, and arranged such that the temperature therewithin is lowest within said lower portion and highest within said upper portion; a fluid conduit system for permitting circulation of said thermal energy carrier fluid in thermal exchange communication with said thermal energy generation source (12) and into and out of said thermal energy storage reservoir (14) so as to maintain the thermal layering within said storage medium within said reservoir (14); wherein said method comprising steps of selectably supplying heat to said upper portion of said reservoir (14), thereby causing a release of cold from the relatively cold layers of said storage medium in said lower portion thereof; and further selectably supplying cold to said lower portion of said reservoir (14) thereby to causing a release of heat from the relatively warm layers of said storage medium in said upper portion thereof, in accordance with the momentary energy requirements of the thermal energy client (16) and the momentary generation capability of said generation source (12).

14. The method according to claim 13, additionally comprising providing a plurality of fluid flow directors (22A, 22B) configured to assure that the volumetric flow of said thermal energy carrier fluid to the thermal energy client (16) and said thermal energy storage reservoir (14) is in accordance with the momentary energy requirements of the energy client (16) and the capability of thermal energy generated by the thermal energy generation source (12); locating said first director in an upstream junction (USJ) communicating said generator (12), client (16) and reservoir (14); functioning said first director (22A) to direct the flow of said fluid from said generator (12) in at least one of two directions, namely towards the client (16) and/or towards the reservoir (14); locating said second director (22B) in a downstream junction (DSJ) communicating said generator (12), client (16) and reservoir (12); functioning said second director (22B) to direct the flow of said fluid towards said generator (12) in at least one of two directions, namely from the client (16) and/or from said reservoir (14), being interconnected with the DSJ-USJ supply line;
wherein the thermal energy consumption of said client (16) is equal to the thermal energy generation capacity of said generator (12), circulating said fluid directly from said generator (12) to the client (16) via said USJ, and vice versa, from the client (16) to the generator (12) via DSJ; and,
wherein the momentary thermal energy requirements of said client (16) is lower than the thermal energy generation capacity of said generator (12), supplying only a portion of said fluid from said generator (12) to said client (16) via said USJ, and supplying the remaining portion by said first director (22A) towards said reservoir (14); in case said generator (12) is adapted to cool the client (16) (a cooling system), supplying a cold fluid to said lower portion of said reservoir (14) thereby to cause a release of heat from the relatively warm layers of said storage medium in said upper portion thereof, yet in case said generator (12) is adapted to heat said client (16) (a heating system), is supplying a worm fluid to said higher portion of said reservoir (14) thereby to cause a release of cold fluid from the relatively cold layers of said storage medium in said lower portion thereof; admixing fluids provided from said reservoir (14) and said client (16) in said DSJ, and is supplying the same to said generator (12) by said second director (22B); in a particular case, wherein the momentary thermal energy requirements of said client (16) is approximately zero, circulating said fluid directly from said generator (12) to said reservoir (14) via said USJ, preferably until the temperature of the outlet fluid at DSJ equals the inlet fluid at USJ.

15. The method according to claim 13, wherein the first temperature is higher than the second temperature and the first extreme position is substantially near the top of said reservoir (14) and the second extreme position is substantially near the bottom of said reservoir (14); or wherein the first temperature is lower than the second temperature and the first extreme position is substantially near the bottom of said reservoir (14) and the second extreme position is substantially near the top of said reservoir (14).
